(19) United States
(12) Patent Application Publication
(10) Pub. No.: US 2012/0065813 A1
(43) Pub. Date: Mar. 15, 2012

(54) SYSTEM AND METHOD FOR COMMAND AND DATA HANDLING IN SPACE FLIGHT ELECTRONICS

(76) Inventors: Quang H. Nguyen, Bethesda, MD (US); William E. Yuknis, Laurel, MD (US); Noosha Haghani, Fulton, MD (US); Scott R. Pursley, Woodstock, MD (US); Omar A. Haddad, South Dayton, FL (US)

(21) Appl. No.: 12/881,587

(22) Filed: Sep. 14, 2010

(51) Int. Cl. G06F 19/00; G06F 11/00; G05D 1/00

(52) U.S. Cl. 701/2; 714/702; 714/E11.004

(57) ABSTRACT

Disclosed herein are systems, methods, and non-transitory computer-readable storage media for controlling hardware on a remote spacecraft. A system practicing the method first identifies a piece of hardware on a remote spacecraft and a desired action for the piece of hardware and generates a command packet configured to instruct the piece of hardware to perform the desired action. The system then generates a container packet for transmission to the remote spacecraft and embeds the command packet within the container packet such that the remote spacecraft decodes the embedded packet to cause the piece of hardware to perform the desired action. Then the system can transmit the embedded packet to the remote spacecraft. Also disclosed herein is a robust, fault-tolerant memory module having strings of memory modules configured with a correction module to detect and correct errors. The memory module can maintain high reliability against severe radiation, mechanical, and thermal effects.

### ORIGIN

The disclosure described herein was made by an employee of the United States Government and may be manufactured and used by or for the Government for governmental purposes without the payment of any royalties thereon or therefore.

### BACKGROUND

1. Technical Field

The present disclosure relates to spacecraft control and more specifically to a command and data handling (C&DH) flight electronics subsystem in a spacecraft.

2. Introduction

The Lunar Reconnaissance Orbiter (LRO) is the first mission in the National Aeronautics and Space Administration's (NASA's) “Vision for Space Exploration”, a plan to return to the moon and then to travel to Mars and beyond. The LRO objectives are to find safe landing sites, locate potential resources, characterize the radiation environment, and demonstrate new technology. Such an LRO mission has many unique requirements for spaceflight qualified electronics, such as data interfaces, command processing, high-capacity instrument data storage and high-speed science data downlink. Previous C&DH designs do not incorporate all of the unique requirements required for the LRO mission. The closest system, the Solar Dynamics Observatory (SDO) C&DH system, does not include any science data storage capacity, multiple data buses, or the capability to interface to more than three instruments. In addition, the mission-specific flight software of the SDO system does not lend itself to be used for the LRO mission.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein is a high-performance, modular command and data handling (CD&H) system. The system can be used, for example, with a lunar reconnaissance orbiter (LRO) or other similar terrestrial and/or space-based missions. In one embodiment, the system includes a complete hardware command and data handling subsystem in a single chassis enclosure that includes a high performance processor, solid state storage, analog collection, switched power services, interfaces to the Ka-Band and S-Band RF communication systems, and data buses including MIL-STD-1553B, custom RS-422, and SpaceWire. One exemplary implementation of the LRO C&DH is designed based on standardization, small physical size, low power, high-performance capability and high reliability for space applications. Three important design aspects include telemetry generation and command processing, collection of science data from instruments, and storage of science and housekeeping data between telemetry downlink passes.

Also disclosed are systems, methods, and non-transitory computer-readable storage media for controlling hardware on a remote spacecraft. In one example, a human or automatic user can control remote hardware on a space-based craft from Earth, another planet, or from any other location remote to the craft. The user can transmit commands to control the remote hardware on one craft or broadcast commands to control the remote hardware on multiple crafts. A system configured to practice the method first identifies a piece of hardware on a remote spacecraft and a desired action for the piece of hardware. Then the system generates at least one command packet, optionally based on the Consultative Committee for Space Data Systems (CCSDS) standard, configured to instruct the piece of hardware to perform the desired action and generates at least one container packet, optionally based on the SpaceWire standard, for transmission to the remote spacecraft. The system embeds the at least one command packet within the at least one container packet to yield at least one embedded packet such that the remote spacecraft decodes the at least one embedded packet and the at least one command packet to cause the piece of hardware to perform the desired action. Finally, the system transmits the at least one embedded packet to the remote spacecraft.

Further, the disclosure includes systems, methods, and non-transitory computer-readable storage media for robust, fault-tolerant memory. This approach can be used to ensure correct access to data stored in memory even under extreme radiation, electrical, mechanical, and thermal conditions, such as those occurring in space. The exemplary robust fault-tolerant memory module includes a set of strings of memory modules, wherein each string of memory modules includes a set of connected memory dies, and wherein each connected memory die includes a set of bits, wherein a first group of bits in each of the set of strings of memory modules is for storing user data and a second group of bits in each of the set of strings of memory modules is for storing check data associated with the user data. The memory module also includes a correction module connected to each of the set of strings of memory modules and is configured to detect and correct errors in the user data based on the check data and based on an error detection and correction algorithm. The correction module can also detect errors periodically and correct errors when a number of detected errors reaches an error threshold. The memory module can distribute storage of one memory word across multiple memory modules in the plurality of strings of memory modules to make data storage more robust from physical or electrical damage, radiation errors, power failure, or malfunction of any one string.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an exemplary command and data handling system architecture;

FIG. 3 illustrates an exemplary command and data handling enclosure;

FIG. 4 illustrates a sample functional block diagram of a memory module;

FIG. 5 illustrates an exemplary arrangement of a number of memory modules;

FIG. 6 illustrates high-level interaction between flight software and SpaceWire hardware;

FIG. 7 illustrates a detailed example command packet structure;

FIG. 8 illustrates a detailed example telemetry packet structure;

FIG. 9 illustrates an exemplary block diagram of data flow between configuration and status registers blocks;

FIG. 10 illustrates an example finite state machine for parsing packets;

FIG. 11 illustrates an example finite state machine for writing to registers;

FIG. 12 illustrates an example finite state machine for reading from registers; and

FIG. 13 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

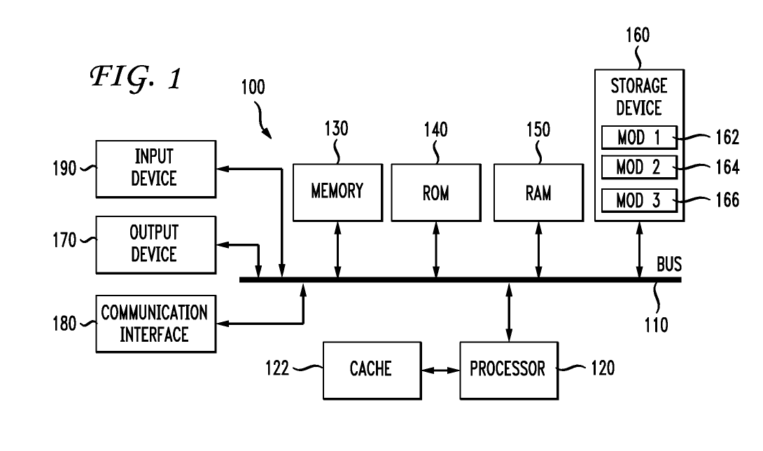

The present disclosure addresses the need in the art for robust memory in the context of a spacecraft. The present disclosure also addresses the need in the art for communicating with a remote, space-based craft. A system, method and non-transitory computer-readable media are disclosed which control hardware on a remote spacecraft. A brief introductory description of a basic general-purpose system or computing device in FIG. 1 is provided which can be employed to practice the concepts disclosed herein. A more detailed description of systems, architectures, packets, finite state machines, and methods will then follow. These variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache of high speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMS) 150, read only memory (ROM) 140, a cable or wireless signal containing a hit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

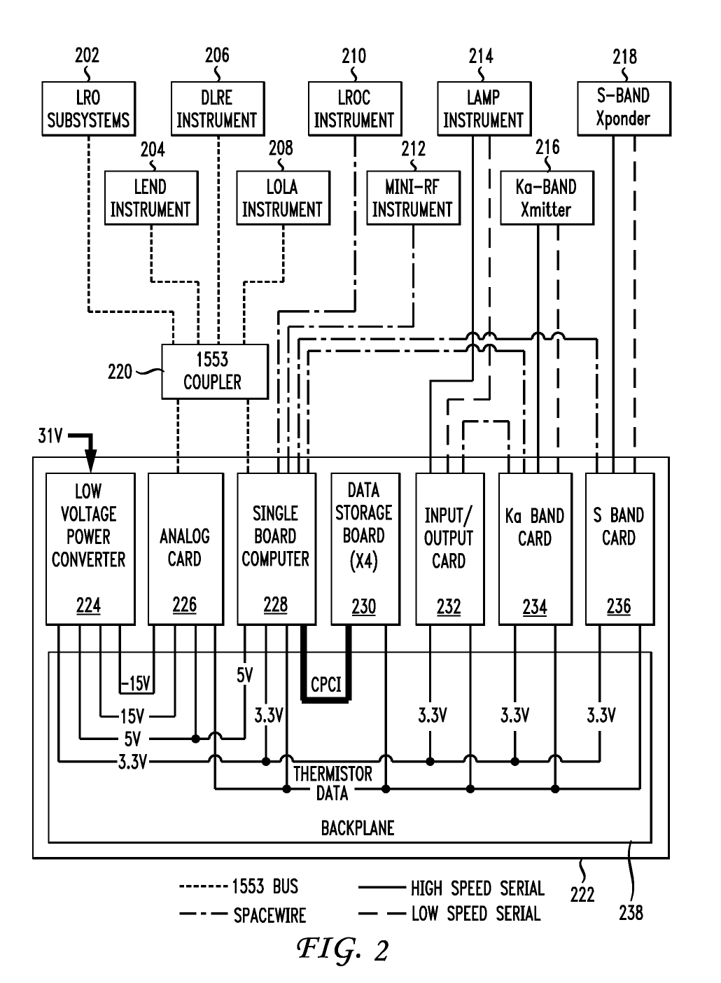

Having disclosed some basic computing system components, the disclosure returns to a discussion of the exemplary command and data handling (C&DH) system as shown in FIG. 2. The C&DH system is a spacecraft data system with the capability to collect science data from the instruments and store it in its data storage system for the Lunar Reconnaissance Orbiter (LRO) mission. The exemplary C&DH system is based on technology such as the Peripheral Component Interconnect (PCI) bus design, SpaceWire networking, Actel Field-programmable gate array (FPGA) design, digital flight design techniques, and VxWorks realtime operating system. While the exemplary CD&H system includes these particular technologies, other suitable technologies can replace or operate in conjunction with these technologies. The hardware architecture depicted in FIG. 2 is based on LRO mission requirements and other configurations are possible.

In this exemplary configuration, the C&DH system includes LRO subsystems 202, a LEND instrument 204, a DLRE instrument 206, and a LOLA instrument 208. These instruments can communicate via a 1553 bus through a 1553 coupler 220 to an analog card 226 and a single board computer (SBC) 228 located in a self-contained enclosure 222.

The use of industry standard interfaces such as SpaceWire, 1553 bus, PCI, and RS-422 allows access to relatively inexpensive and commercially available data simulators for ground support equipment. The C&DH system can include field-programmable gate arrays (FPGAs), such as FPGAs from Actel, including the Four-Port SpaceWire Router Core and the PCI interface core. For example, digital logic can maximize the use of the Actel radiation-tolerant RTAX-2000 FPGA as much as possible or practical.

In one aspect, the LRO system utilizes two radio frequency (RF) band modules, an S-band transponder 218 and a Ka-Band transmitter 216, for communication with Earth. The system uses the S-Band for command and telemetry of housekeeping data. The system uses the Ka-Band for high speed data transfer of science data. To accommodate this, the C&DH utilizes two similar designs on a single assembly, with each design dedicated to a single band. The exemplary system also uses the SpaceWire standard and MIL-STD-1553 for expandability and scalability. For example, the spacecraft can accommodate late addition of additional nodes anywhere in the spacecraft and attach the additional nodes to the C&DH SpaceWire network seamlessly. The C&DH provides a mission unique interface to the Lyman-Alpha Mapping Project (LAMP) instrument 214 as well as providing timing synchronization to all the instruments.

The C&DH can provide a mass storage system via one or more data storage boards 230 for the LRO spacecraft with a storage capacity of 48 GB. The system can store data collected from the instruments and the avionics housekeeping data within this mass storage system prior to playback or transmission during a telemetry pass.

FIG. 2 depicts the C&DH subsystem with ten exemplary sub-assemblies. FIG. 2 illustrates a top-level block diagram of the C&DH with the LRO Avionics and instrument interfaces. FIG. 2 also shows the interconnections between the C&DH sub-assemblies and other subsystems, such as the Ka-Band transmitter 216, S-Band transponder 218, and seven LRO instruments 202-214.

The disclosure now turns to a discussion of the various C&DH sub-assemblies. The exemplary C&DH system includes an enclosure 222, a backplane 238, a low voltage power converter 224, a single board computer (SBC) 228, a Ka-Band communications interface board 234, an S-Band communications interface board 236, one or more data storage boards 230, a housekeeping and digital input/output (HKIO) board 232, and a multifunction analog data acquisition card (MAC) 226. These components are all contained within the same C&DH enclosure 222. The backplane 238 makes all electrical connections between these components for internal power distribution and PCI bus data transfers. The interfaces between the C&DH and the instruments and avionics are connected through a SpaceWire network, a MIL-STD-1553 bus (via a 1553 coupler 220), and a combination of synchronous and asynchronous serial data transfers over RS-422 and low-voltage differential signaling (LVDS) electrical interfaces. The C&DH system acts as the spacecraft data system with an instrument data manager providing all software and internal bus scheduling, ingestion of science data, distribution of commands, and performing science operations in real-time.

The SBC 228 is the processing platform for the flight software (FSW) and the attitude control software (ACS). In one exemplary configuration, the SBC 228 utilizes the RAD750 processor, operating at a frequency of 133 MHz. The SBC 228 is designed to be immune to latchup and sustain up to 50 Krads of total ionizing dose. The SBC 228 contains, for example, 36 MB of Static Random Access Memory (SRAM) for storing executable code and housekeeping data, 64 kilobytes of Start Up Read-Only Memory (SUROM) for storing essential bootstrap code, and 4 MB of Electrically Erasable Programmable Read-Only Memory (EEPROM) for storing application code. The EEPROM can be arranged as two banks to store two copies of the application code. The SBC 228 operates as the bus controller for the 1553 bus to communicate with LRO subsystems and the instruments. The SBC 228 provides multiple SpaceWire interfaces to communicate, for example, with the Lunar Reconnaissance Orbiter Camera (LROC) 210, Mini-RF instruments 212, the S-Band communication card 236, and the Ka-Band communication card 234. The backplane 238 connector provides a compact PCI bus interface over which the SBC 228 transfers data to the data storage boards 230.

In one embodiment, the HKIO 232 is a mission unique board that provides three functions within the C&DH. The first function of the HKIO 232 is distribution of a periodic signal, such as a 1 pulse per second (PPS) signal, to the LRO system. The second function of the HKIO 232 is to maintain a mission elapsed timer (MET). The third function of the HKIO 232 is to provide an interface for the LAMP instrument 214. The HKIO 232 can generate the 1 PPS signal via a 20 MHz clock from one of the two ultra stable oscillators (USO). The system uses MET to maintain the time of received uplink commands and as a mechanism for time synchronization. The HKIO 232 can provide both electrical and data connectivity to the LAMP instrument 214 through two serial interfaces, one high speed interface using low voltage differential signaling (LVDS) and one low speed interface using the RS-422 standard. The science data and commands to and from the LAMP instrument 214 go through the HKIO board 232 and flow to the SBC 228 using a SpaceWire link.

The Multi-Function Analog Card (MAC) 226 provides analog connectivity for the C&DH for its internal telemetry for voltage monitoring and internal thermistors in addition to all the analog data from the LRO spacecraft. The analog data from the LRO spacecraft includes, for example, thermistors, platinum resistance thermometers, hinge potentiometers, coarse sun sensors, various analog telemetry points, and pressure transducers. The MAC 226 digitizes all the analog data and generates telemetry and receives commands over the 1553 bus. In addition to providing analog telemetry values, the MAC 226 can also provide multiple switched power services. The services provide the spacecraft bus voltage to various heaters located near the LROC instrument and are controlled by flight software.

The one or more data storage boards (DSBs) 230 are part of a file system that handles the storage and retrieval of files. One exemplary embodiment uses four DSBs 230. The DSBs 230 provide, for example, 48 GB of Beginning of Life (BOL) memory capacity for storing science and housekeeping data during a 17.5 hour time interval between Ka-Band downlink passes. The SBC 228 supports the file system mechanisms using FAT32, EXT2, or ZFS, for example. The DSB 230 can include error detection and correction (EDAC) logic to correct up to 2 nibbles (4 bits per nibble for a total of 8 bits) in error and to detecting three or more nibbles in error. The EDAC can be implemented using a form of short Reed Solomon coding. In addition to the EDAC, the DSB 230 provides a hardware and/or software scrubber that clears or corrects bit errors out of memory. The scrubber can be completely autonomous and operate without additional software support or human interaction.

In one embodiment, the Lunar Reconnaissance Orbiter has a solid state recorder in the form of four memory boards. Because LRO is a single string spacecraft and is susceptible to radiation effects and severe mechanical and thermal effects, a high degree of reliability is desired and a more graceful degradation. The disclosed memory board can tolerate a wide variety and relatively large number of memory device failures while continuing to operate correctly.

The individual memory boards 230 can utilize synchronous dynamic random access memory (SDRAM) memory technology which is particularly sensitive to radiation effects which manifest as bit flips or functional interrupts, for example. The memory boards 230 employ multiple strategies. First, the memory boards 230 use of an error detection and correction (EDAC) algorithm to detect and correct bit errors. One example EDAC algorithm is a parallel Reed-Solomon algorithm, but other algorithms can be used such as the Berlekamp-Massey algorithm, the Peterson-Gorenstein-Zierler algorithm, or Hamming codes. Second, the memory boards 230 use scrubbing which is a technique to use the EDAC to periodically go through the memory to clear out bit errors before they exceed an error threshold, such as the EDAC's capability to correct. Third, the memory boards 230 arrange the memory data words in a way such that memory device failures are still within the EDAC's capability to correct and still provide usable memory.

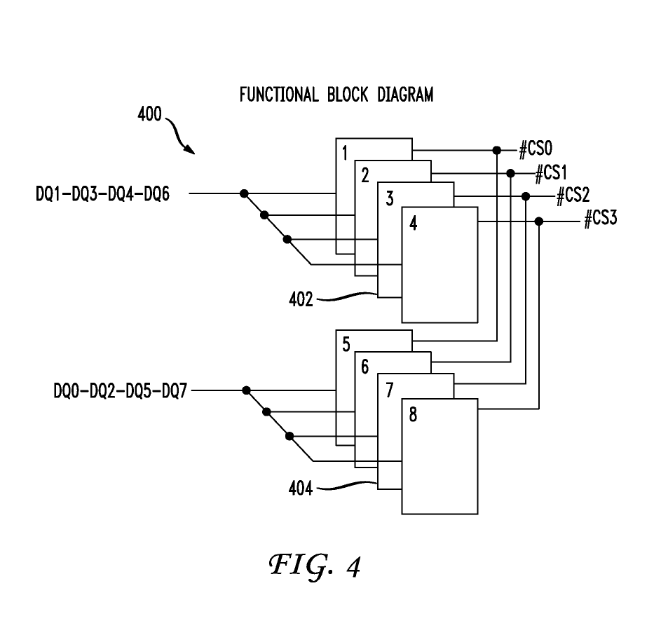

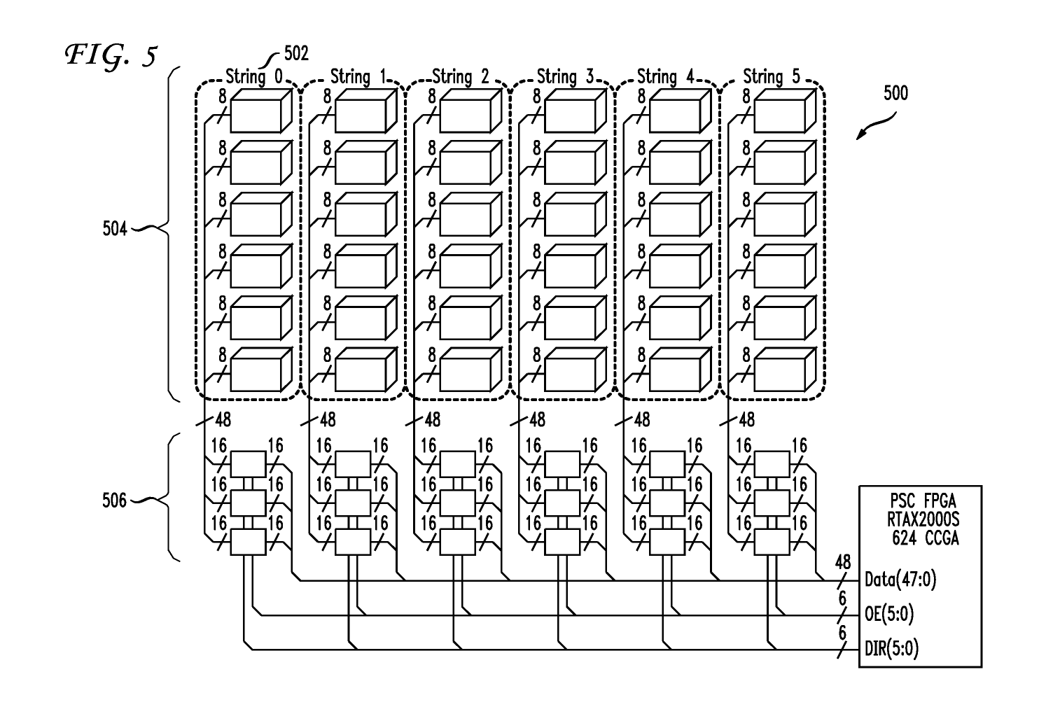

FIG. 4 shows a functional block diagram of the memory architecture 400. The architecture includes two memory dies 402, 404 each with 4-bit wide (also known as nibbles) data paths arranged as a single 8-bit data word. A number of these memory modules are arranged as strings of six of these memory dies as shown in FIG. 5.

FIG. 5 illustrates an exemplary arrangement 500 of a number of memory modules into six strings, labeled string 0 to string 5. String 0 502, and the other strings, includes six memory modules 504, each of which can hold an 8-bit data word. Combined, these six memory modules 504 create a 48-bit data word. Each 48-bit data word is connected to a memory controller (implemented as a field programmable gate array) that contains EDAC logic circuitry. Of the 48 bits, 32 bits are data for the user, and 16 bits 506 are EDAC check bits. By choosing a suitable EDAC algorithm, the system can correct up to 2 nibbles (including the EDAC check bits themselves) and still produce correct data. Because the EDAC is capable of correcting two nibbles, this results in the ability to tolerate a failure of a single module in any string or a failure or loss of any single string and still operate correctly. This provides a very high degree of reliability and robustness against mechanical, thermal, and electrical failure as well as radiation effects within a single module. To provide additional robustness, the system can store the bits of a single memory word across multiple memory modules so that the EDAC can correct for failure in any one of the memory modules and still operate correctly.

The disclosure now returns to a discussion of FIG. 2. In one implementation, a DSB 230 includes banks of synchronous dynamic random access memory (SDRAM) packaged in flight qualified high-density memory modules as the memory storage element. The DSB 230 can turn off one or more bank of SDRAM on one or more board to conserve power when needed or to avoid using damaged or unusable banks. The system transfers data and configures the DSBs 230 via the compact PCI interface through the backplane connector 238.

The exemplary Ka-Band Communications Card 234, or Ka-Comm card, provides high-speed telemetry to Earth using Ka-Band frequencies. For LRO, the Ka-Comm card 234 connects to the SBC 228 via a SpaceWire link. During a Ka-Band pass, the data from the SBC 228 flows directly into the Ka-Comm card 234 at the SpaceWire link rate of 132 megabits per second (Mbps). The telemetry data rate itself is 100 Mbps. Once the Ka-Comm card 234 receives the data from the SBC 228, the Ka-Comm card 234 encodes the data for transmission. The Ka-Comm card 234 can encode the data according to Consultative Committee for Space Data Systems (CCSDS) recommendations for telemetry encoding or some other proprietary or open standard. The Ka-Comm card 234 can also split the telemetry stream into two streams for offset quadrature phase shift keying (OQPSK) modulation. The Ka-Comm card 234 sends the two streams to a Ka-Band transmitter 216, which in turn modulates the data onto a radio-frequency (RF) carrier and transmits the data via RF through a high gain antenna (HGA). In addition to providing telemetry to the Ka-Band transmitter 216, the Ka-Comm card 234 can also provide command and control and receive housekeeping telemetry from the Ka-Band transmitter 216 itself by using an asynchronous low rate serial interface with RS-422.

The S-Band Communications Card 236, or S-Comm card, provides telemetry and receives commands to and from Earth using S-Band frequencies. In one LRO implementation, the S-Comm card 236 connects directly to the SBC 228 via a SpaceWire link. During a pass, the data from the SBC 228 flows directly into the S-Comm card 236 at the SpaceWire link rate of 10 Mbps, where the telemetry data rate is a maximum 1 Mbps. Once the S-Comm card 236 receives the data from the SBC 228, the S-Comm card 236 encodes the data for transmission. The S-Comm card can encode the data according to CCSDS recommendations or some other proprietary or open standard for telemetry encoding. The S-Comm card 236 provides a single data stream for Bi-Phase Shift Keying (BPSK) modulation in the S-Band transmitter 218. The S-Comm card 236 sends the data stream to the S-Band transponder 218, at various data rates up to 1.093 Mbps (2.186 Mbps symbol rate), which is in turn modulated onto a RF carrier and transmitted through the HGA and/or omnidirectional antennas.

For commands, S-Comm card 236 accepts CCSDS telecommands from the S-Band transponder 218 at various rates up to 4 kilobits per second (Kbps). The S-Comm card 236 can also generate a timing pulse upon receipt of command for time correlation with the ground stations. The S-Comm card 236 also provides command and control and receives housekeeping telemetry from the S-Band transponder 218 itself, for example, by using an asynchronous low rate serial interface over RS-422. Finally, the S-Comm card 236 can process and directly execute hardware-decoded commands. The S-Comm card 236 can recognize multiple hardware-decoded commands, including as RS-422 outputs and low voltage transistor-transistor logic (TTL).

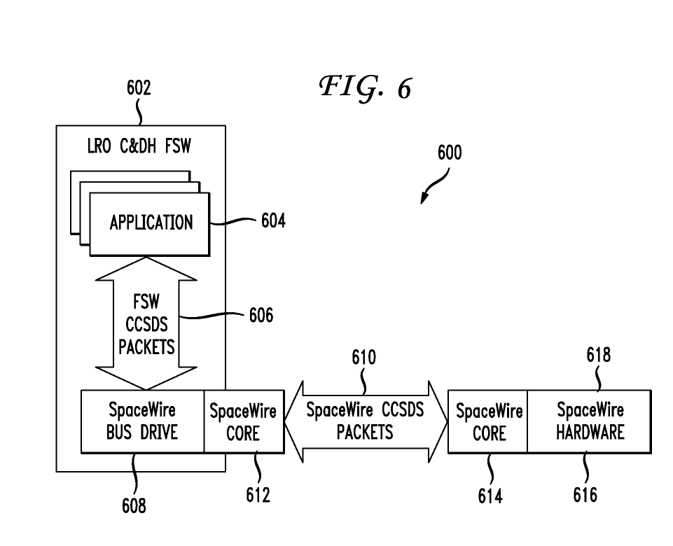

FIG. 6 illustrates an exemplary high level CCSDS communication structure 600 that can be used to communicate via the S-Band transponder 218 and/or the Ka-Band transmitter 216. The interaction between the LRO C&DH flight software (FSW) 602 and individual applications 604 within the FSW and the connected SpaceWire hardware 618 flows as CCSDS packets 606 to a SpaceWire Bus Driver 608. The SpaceWire Bus Driver 608 uses a SpaceWire Core module 612 to encode those interactions as SpaceWire CCSDS packets 610 which are interpreted and/or extracted by the SpaceWire hardware 616 via a SpaceWire Core module 614. The software application 604 generates CCSDS packets 606 which the SpaceWire Bus Driver 608 forwards to the SpaceWire hardware 616 as complete packets for further processing.

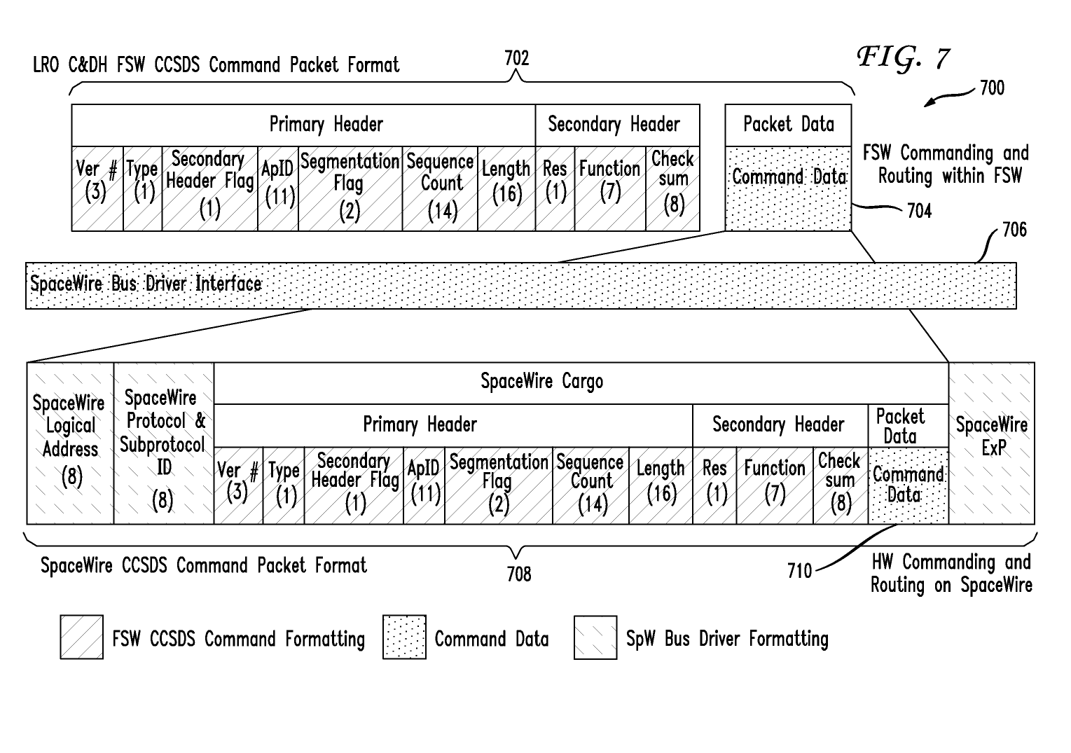

FIG. 7 illustrates a detailed example command packet structure 700 in the context of the high level CCSDS communication structure 600 shown in FIG. 6. A LRO C&DH FSW CCSDS command packet 702 includes a primary header, a secondary header, and packet data 704. The command data 704 is extracted via the SpaceWire Bus Driver interface 706 to produce a SpaceWire CCSDS Command Packet 708 with multiple components including additional command data 710. The table below provides an example description of bits embedded within the CCSDS packets.

TABLE 1

| CCSDS | | |
|---|---|---|
| Command | | |
| Packet | | Length |
| Field | Definition | (in bits) |
| Ver # | Fixed Value, Version = 0 | 3 |
| Type | Fixed Value, Command = 1 | 1 |
| Sec Header | Fixed Value, Secondary Header Present = 1 | 1 |
| Flag | | |
| APID | Instrument Subsystem ApID. The Application | 11 |
| | process ID (ApID) is instrument defined for use | |
| | for command routing, selection, or decoding. | |
| Segment | Fixed Value, No Segmentation allowed = 3 | 2 |
| Flags | | |
| Source | The Source Sequence Count is used to indicate | 14 |
| Sequence | command sequence for detecting command | |
| Count | duplication. Not used by LRO HW. | |
| Packet | CCSDS defined length. This is the length of the | 16 |
| Length | entire packet in bytes (or octets) minus the | |
| | length of the primary header (6 bytes) minus 1. | |
| Secondary | User to indicate the type of secondary header. ‘1’ | |
| Header | indicates standard CCSDS secondary header, ‘0’ | |
| Type | indicates non-standard CCSDS secondary header. | |
| | This field will always be ‘0’ for LRO. | |
| Function | Subsystem Function Code. Hardware defined | 7 |
| Code | for use for command selection or decoding. | |
| Checksum | Checksum for checking entire | 8 |
| | CCSDS packet (header and data fields) | |
| | and does include SpaceWire headers. | |
| Command | Instrument Command Data. The Command | Up to |
| Data | data is instrument defined to support | 65534 |
| | instrument commanding. | bytes |
| Operand | Indicates read or write action. A read is indicated | |
| | by ‘0’ and a write is indicated by ‘1’. Read | |
| | responses are sent via CCSDS telemetry packets. | |
| Address/ | Defines a particular address or function to be | 5 . . . 0 |
| Function | selected or performed. Defined in a separate | |
| | ICD for the target HW. | |

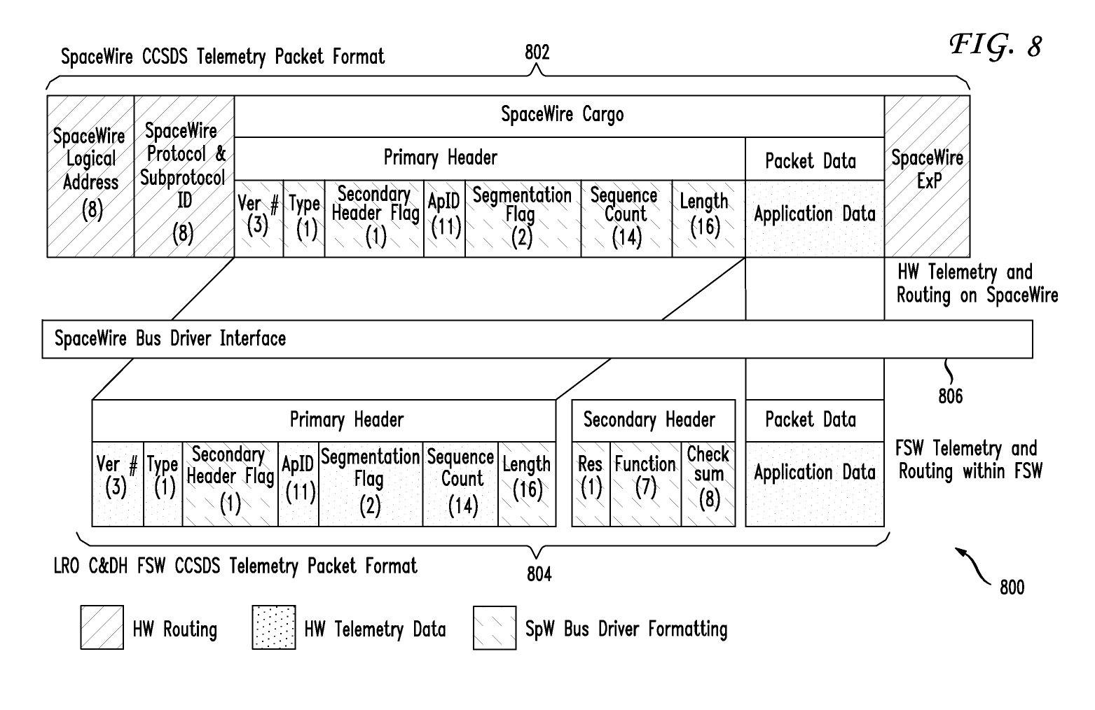

FIG. 8 illustrates a detailed example telemetry packet structure 800 in the context of the high level CCSDS communication structure 600 shown in FIG. 6. A SpaceWire CCSDS command packet 802 includes a primary header and packet data as SpaceWire cargo, and other components. The SpaceWire cargo is extracted via the SpaceWire Bus Driver interface 806 to produce an LRO C&DH FSW CCSDS telemetry packet 804 from the SpaceWire cargo. Table 2 below provides an example description of bits embedded within the CCSDS packets, and Table 3 below shows the mapping of unique CCSDS application IDs with SpaceWire logical addresses. The purpose is to bind these application IDs with logical addresses so that the hardware can be programmed with these values.

TABLE 2

| CCSDS | | |
|---|---|---|
| Telemetry | | Length |
| Packet Field | Telemetry Definition | (in bits) |
| Ver # | Fixed Value, Version = 0 | 3 |
| Type | Fixed Value. Command = 1 | 1 |
| Sec Header | Fixed Value, Secondary Header Present = 1 | 1 |
| Flag | | |
| APID | HW Defined Telemetry ID. The SpW CCSDS telemetry packet | 11 |
| | ApID is assigned at the telemetry source by the instrument | |
| | hardware. Each different telemetry packet generated at the | |
| | instrument hardware requires a unique SpW CCSDS telemetry | |
| | packet ApID. | |
| Segment | No Segmentation allowed = 11 | 2 |
| Flags | | |
| Source | HW Defined. Unused for LRO. | 14 |
| Sequence | | |
| Count | | |
| Packet Length | HW defined. The packet length field is the byte count of the | 16 |
| | length of the entire packet in bytes (or octets) minus the length | |
| | of the primary header (6 bytes) minus 1. | |
| Telemetry | HW Defined. Size is limited by FSW later insertion of timecode | Up to |
| Data | (48 bits). | 65536 |
| | | bytes |

TABLE 3

| | | SpaceWire | |
|---|---|---|---|
| | | Destination | |
| | CCSDS | Logical | |
| | AppID | Address | Description |
| SSR | 1000 | 32 | SSR Control Commands |
| | 1001 | 33 | SSR High Priority reads/writes |
| | 1002 | 34 | SSR Low Priority reads/writes |
| SBC | 1010 | 64 | SBC non-LROC SpW traffic |
| | 1011 | 65 | SBC-LROC Dedicated Port |
| S-Comm | N/A | 128 | S-Band Downlink |
| | 1021 | 128 | S-Band Uplink |
| | 1022 | 130 | Relay Operations I/F |
| | 1023 | 131 | S-Band Transponder Serial I/F |
| | 1024 | 132 | S-Band Configuration & Status |
| Ka-Comm | N/A | 140 | Ka-Band Downlink #1 |
| | N/A | 141 | Ka-Band Downlink #2 |
| | 1032 | 142 | Ka-Band Transmitter Serial I/F |
| | 1033 | 143 | Ka-Band Configuration & Status |
| LROC | 1040 | 160 | LROC SCS Control Cmds |
| | 1041 | 161 | LROC File Read Reply Msgs |
| | 1042 | 162 | LROC File Write Reply Msgs |
| HKI/O | 1050 | 192 | LAMP high speed serial interface |
| | 1051 | 193 | LAMP low speed serial interface |
| | 1052 | 194 | Generic UART interface |
| | 1053 | 195 | HKIO configuration and status |
| SAR | 1060 | 200 | Mini-RF/SAR Data Port #1 |
| | 1061 | 201 | Mini-RF/SAR Data Port #2 |

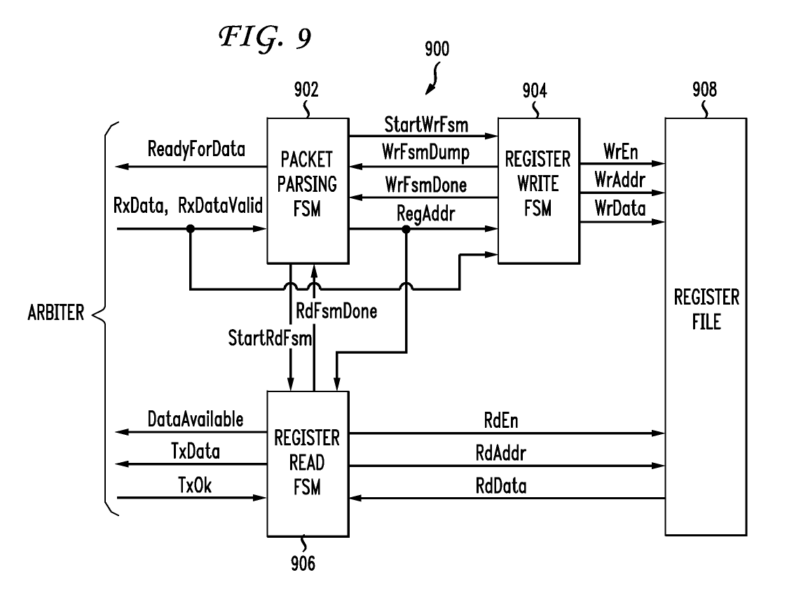

FIG. 9 illustrates an exemplary block diagram 900 of data flow between configuration and status registers blocks. The Packet Parsing finite state machine (FSM) 902 receives a command packet from the SBC 228. If the packet is a register write packet, the Register Write FSM 904 combines the write value in to a 32-bit value and writes to the register file 908. When a read command packet is received, the Register Read FSM 906 reads data from the register file 908 and forms a response packet that is sent to the SBC 228. The Packet Parsing FSM 902 typically processes commands in the order received.

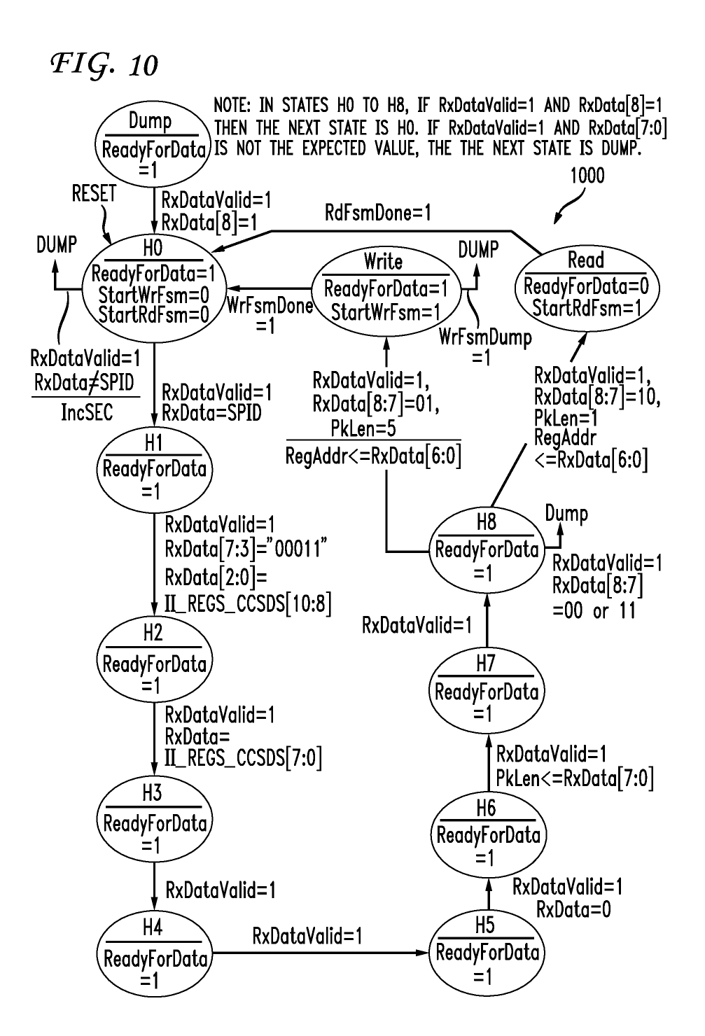

FIG. 10 illustrates an example packet parsing finite state machine 1000 as shown in FIG. 9, 902. The Packet Parsing FSM is starts in the HO state. When the packet parsing FSM 1000 receives a packet, it examines and validates each byte of the header. If any byte is not as expected, the packet parsing FSM 1000 jumps to the Dump state until it detects an EOP. If the first header byte does not match the SPID from the HK_CFG register, the IncSEC signal is pulsed to increment the SPID Error Counter. After the header has been validated, if the packet is a write command, the packet parsing FSM 1000 starts the Register Write FSM 904, 1100 using the StartWrFsm signal. When the Register Write FSM 904, 1100 has processed the write to the register file, it strobes the WrFsmDone signal to allow the Packet Parsing FSM. If an EOP is not detected after the write data has been received, the packet parsing FSM 1000 proceeds to the Dump state until an EOP is detected. If the packet is a read command, the Register Read FSM's StartRdFsm is asserted. While a response packet is being sent, the packet parsing FSM 1000 will deassert its ReadyForData signal to hold back succeeding command packets and ensure the proper order of real/write command processing.

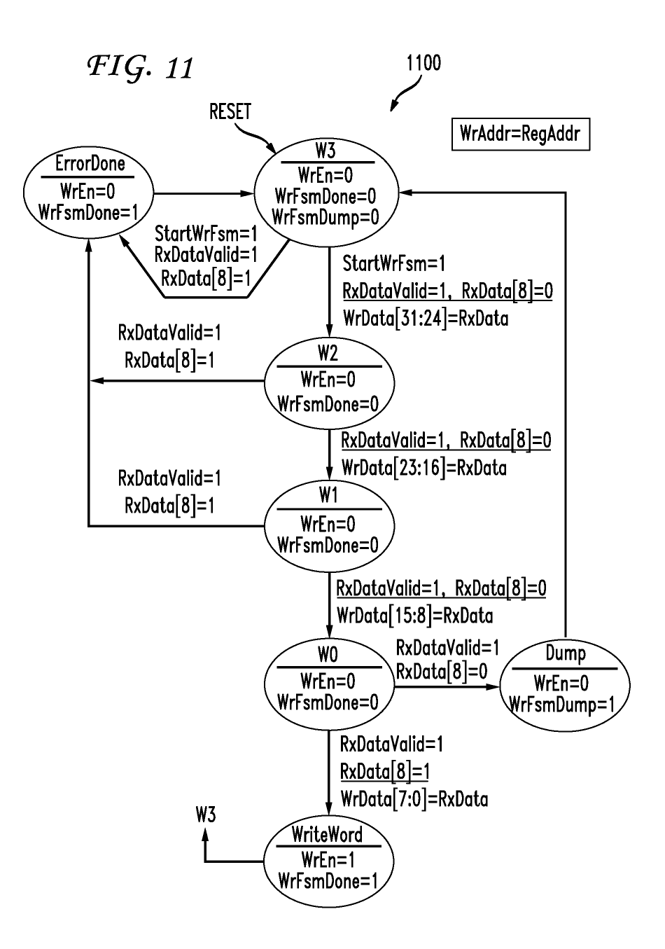

FIG. 11 illustrates an example register write finite state machine 1100 as shown in FIG. 9, 904. The register write FSM 1100 waits in the W3 state until the StartWrFsm signal is asserted. Received write data is stored in a 32-bit register named WrData one byte at a time. If an EOP is received prematurely, the register write is aborted and the register write FSM 1100 jumps to the ErrorDone state for one clock in order to assert the WrFsmDone signal. Also, if the last byte of write data does not contain an EOP, the write is aborted. In this case, remaining packet data must be dumped. If the last byte of the write data contains an EOP, then the state machine proceeds to the WriteWord state then resets to the W3 state.

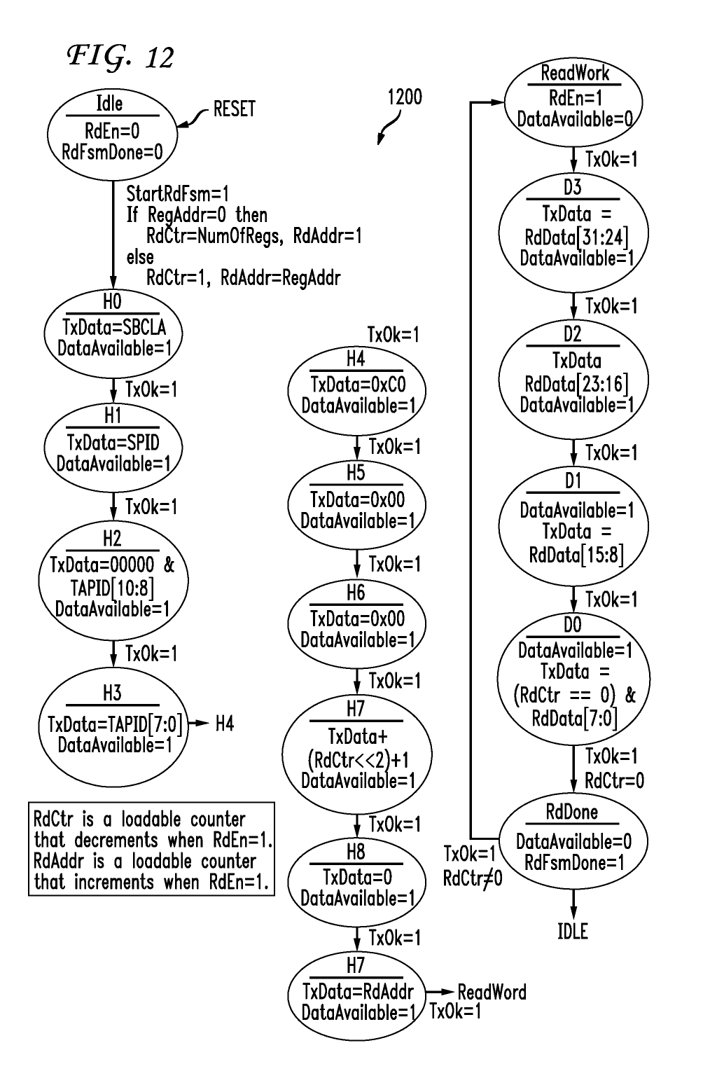

FIG. 12 illustrates an example register read FSM 1200 as shown in FIG. 9, 906. The register read FSM 1200 waits in the idle state until the StartRdFsm signal is asserted. When started, the RdCtr and RdAddr registers are set according to RegAddr to either read one register or all registers. The response packet header is then formed. When the Read state is reached, a 32-bit value is read from the register file and written to the SpaceWire router one byte at a time. When the second last data byte is written, the RdCtr is decremented and RdAddr is incremented so that the last data byte can be written with a valid EOP, if needed. When the last data byte is written, if the RdCtr is 0, then the RdFsmDone signal is asserted and state machine is reset. If RdCtr is not 0, the next register is read from the register file and appended to the packet.

The disclosure now returns to a discussion of FIG. 2. The exemplary Low Voltage Power Converter (LVPC) can convert an input voltage with an operational range of +21 volts DC to +35 volts DC from the LRO spacecraft to provide voltage outputs of +3.3 VDC, +5 VDC and +/−15 VDC with electromagnetic interference (EMI) filtering. The LVPC can contain circuitry that drives the magnetic relays to provide power for several components of LRO's RF system, such as the S-Band antenna transfer switch and the Ka-Band Traveling Wave Tube Amplifier (TWTA) power relay.

The backplane 238 provides interconnectivity for multiple cards in the LRO C&DH system and can reside within or be integrated as part of a C&DH enclosure. For example, the backplane 238 can connect the S-Band and Ka-Band communication cards 234, 236, the HKIO card 232, the MAC 226, the LVPC 224, the SBC 228, and one or more DSB cards 230. The backplane 238 accommodates each card that connects to it with a unique interface. The backplane can distribute the voltage outputs from the LVPC. The backplane 238 can provide +5 VDC to the SBC 228 and the MAC 226. In addition, the backplane 238 can provide +3.3 VDC to all of the boards within the C&DH enclosure and +15 VDC to the MAC 226 and the DSBs 230, and −15 VDC to the MAC 226. The backplane 238 can also provide a compact PCI bus interface rated for 33 MHz data transfers between the SBC 228 and DSBs 230. The backplane 238 can provide and distribute thermistor data from one or more board to the MAC 226 as part of the housekeeping data collection.

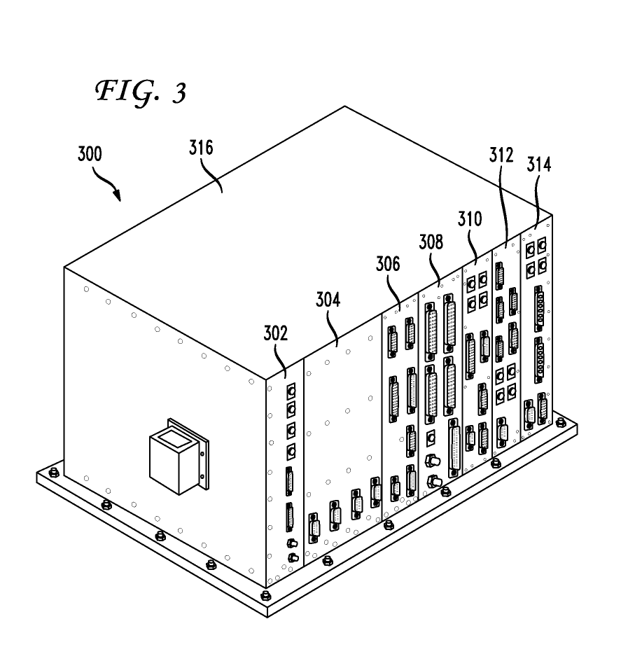

FIG. 3 illustrates an exemplary C&DH enclosure 300, such as the enclosure 222 illustrated in FIG. 2, that acts as the mechanical housing for the C&DH unit and contains all of the C&DH hardware assemblies 302-314 connected via a backplane 316. An exemplary C&DH enclosure is 16″×11.5″×9.75″ and weighs 46 pounds with all subassemblies installed. The C&DH enclosure can be mounted on an isothermal panel (ITP) of LRO's avionics deck. The flange at the base of the C&DH enclosure can attach the C&DH to the LRO structure with multiple fasteners, such as screws or rivets.

The disclosure now turns to a discussion of several significant operational performance metrics. The first performance metric is spacecraft autonomy. The baseline on-orbit LRO ground contact plan is four Ka-band downlink passes per day having a duration of 45 minutes each and twelve S-Band downlinks/uplinks contacts per day having a duration of at least 30 minutes each. Between the ground contacts, the flight software hosted on the C&DH system provides autonomous operation of the spacecraft by issuing preplanned commands uploaded by ground into the processor's stored command memory. The flight software monitors the spacecraft house-keeping data for anomalies and responds to them with appropriate actions. Under worst case conditions, the spacecraft can miss ground contacts for periods of up to 28 hours and still sustain itself without disrupting normal operations.

The second performance metric is processor utilization and power dissipation. The C&DH can maintain less than 80% processor utilization under worst case conditions. The C&DH processor utilization is measured to be an average slightly less than 80% while a Ka-Band pass is active at 100 Mbps in addition to performing normal operational functions and collecting and processing science data. In this configuration, the C&DH consumed a steady state power draw of 95 Watts.

The third performance metric is a watchdog strategy. LRO utilizes a single string design architecture except where safety and reliability concerns require additional protection. As a result, the C&DH is built with minimal hardware redundancy. To mitigate the risk associated with a single string design, the watchdog strategy for the C&DH can be implemented in both hardware and software. Several layers of protection are provided to handle processor faults and memory anomalies caused by software and/or hardware errors, including Single Event Upset (SEU) and latchup, which is an accidental creation of a low-impedance path between power supply rails that triggers a parasitic structure disrupting proper functionality. The watchdog strategy utilizes a layered hierarchy that provides increasing levels of intervention and protection. The first layer is a software based watchdog in the flight software, followed by a second layer software based watchdog on the SBC. The last layer is the hardware watchdog on the S-Comm Card which recycles the power to the C&DH by issuing a command the LVPC as a last resort.

The fourth performance metric is science data collection. The system collects data from all the science instruments into files in the C&DH's data storage system. These files are constantly created while LRO orbits the moon. The science data is downlinked as much as possible during the Ka-Band passes by using the CCSDS file delivery protocol (CFDP). CFDP can ensure that the science data is transferred in its entirety and without errors before removing the transferred data from the data storage system to free up space for new data.

The fifth performance metric relates to ultra stable oscillators. The C&DH can include multiple Ultra Stable Oscillators (USO), such as a primary USO and a redundant or backup USO. The system powers one of the oscillators at any given time. Each oscillator can provide two 20 MHz clock signals. One clock signal goes to the C&DH HKIO card for 1 PPS generation and the second clock signal goes directly to the Lunar Orbiter Laser Altimeter (LOLA) instrument. The primary and/or redundant USO can be extremely high accuracy. For example, the primary USO can meet a frequency stability factor of 10 parts per billion (ppb) over one millisecond (ms) and the redundant USO can meet a frequency stability factor of 0.3 parts per million (ppm) over 1 ms. The oscillators can provide sufficient stability to meet the needs of the laser ranging system component of the LOLA instrument.

The disclosure now turns to several fabrication approaches that can be used to implement a spacecraft based C&DH system. For example, some considerations for space-based operation include size, weight, energy requirements, vibration, temperature, and so forth. A combination of at least three exemplary fabrication processes can yield a C&DH system within the appropriate requirements, including surface mount technology (SMT) components, ceramic column grid array (CCGA) packaging for semiconductor devices, and two-sided printed wiring board assemblies (PWA) with a heat sink core.

The disclosure first turns to surface mount technology (SMT). Most of the exemplary C&DH subassemblies include SMT components. The various C&DH subassemblies can incorporate a variety of SMT package styles such as flat-packs, quad flat-packs and leadless chip carrier (LCC). SMT can provide at least two significant advantages, such as the small physical size of the components and the ability to use an automated assembly process. Automated assembly can significantly improve the quality of the sub-assemblies by providing consistency throughout the assembly process. However, for space flight use, SMT manufacturing processes must pass crucial thermal cycling qualification based on the mission environment profile. SMT components must be capable of withstanding potentially hundreds of thermal cycles over the mission's design life.

The disclosure now turns to ceramic column grid array (CCGA) design. CCGA array packaging can be used for the field programmable gate array device (FPGA) on the DSB. CCGA packaging technology provided a sufficient number of input/output (I/O) pins for the DSB design in addition to providing a considerably smaller footprint with a comparable FPGA utilizing the ceramic quad flat-pack (CQFP) packaging. The DSB is made more rigid by attaching a stiffening frame to the heat sink to meet the CCGA structural design criteria. For a CCGA device, the card deflection ratio must be sufficient with margin to ensure that the solder joints of the CCGA device do not fail.

The next fabrication approach is a two-sided printed wiring board (PWB) assembly. Each C&DH sub-assembly can consist of a double-sided or single-sided printed wiring board (up to 12 layers 6U-160 mm), a heat sink plate, two wedge locks, an edge connector, a stiffener and/or a front panel. The aluminum heat sink is sandwiched between the two PWBs. The wedge locks can be mounted on both long edges of the heat sink. For the DSBs and the SBC, the assembly can be electrically and physically connected to the backplane, such as via a HyperTronic compact PCI (cPCI) connector. The remaining boards (HKIO, MAC, Ka-Comm, S-Comm) can utilize a 184-pin edge connector. A stiffener can be attached to the heat sink to reduce the board deflection and dynamic stresses due to vibration.

Z-wires can provide electrical connections between two PWBs on the same assembly. However, the amount of z-wires can be reduced where possible to improve the reliability of the overall assembly. The solder joint of the z-wire can be thoroughly inspected during manufacturing. Z-wires can reduce the overall signal length by providing a more direct path between two connection points. Signal integrity analysis can be used to optimize the layout process.

A finite element analysis (FEA) can help determine a suitable fabrication technique to mount the SDRAM packages onto the DSB assembly. The FEA can illustrate stresses on the corners of the SDRAM devices and pinpoint which areas require epoxy to bring down the stress levels to within allowable limits for vibration levels.

Due to the use of high speed signals with fast edge rates, signal integrity (SI) analysis can be performed on digital PWB designs of the C&DH. The prevalence of the high speed digital logic elements can necessitate an analysis of all the signal interconnects for all the boards to ensure that the signals were within specifications with regard to monotonicity, overshoot, and undershoot. The signal integrity analysis can be performed during the board layout and signal routing phases to determine whether signals need to be terminated to address signal integrity. The analysis can also ensure that all digital signals are within the component's electrical specification. In addition to signal quality, the effects of crosstalk on all signals can be analyzed and mitigated where possible. In one aspect, the C&DH is designed for an operating temperature range of −10 C to +40 C and a survival temperature range of −20 C to +50 C.

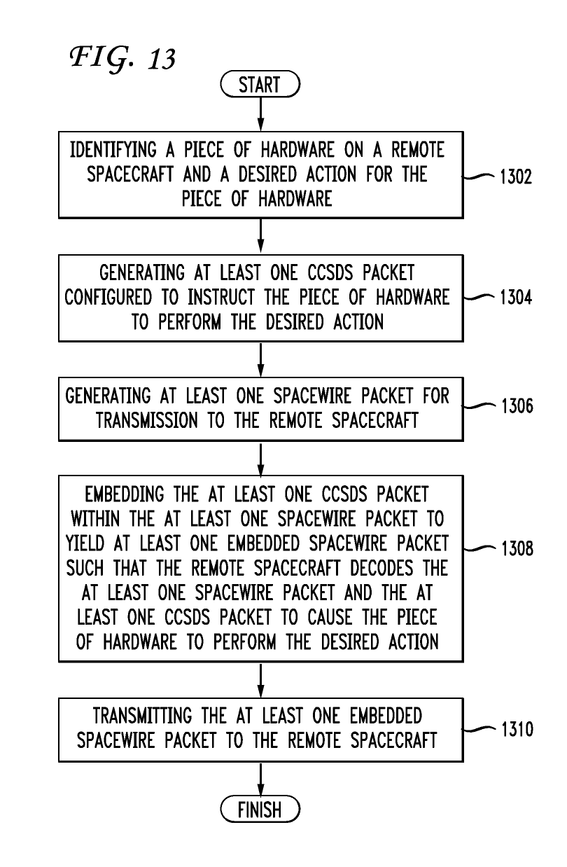

Having disclosed some exemplary system components, packet arrangements, finite state machines, and concepts, the disclosure now turns to the example method embodiment shown in FIG. 13. For the sake of clarity, the method is discussed in terms of an exemplary system 100 as shown in FIG. 1 configured to practice the method. The system 100 first identifies a piece of hardware on a remote spacecraft and a desired action for the piece of hardware (1302). The desired action can include, for example, one or more of reading data, writing data, transmitting data, physical movement, engaging certain electrical components, and so forth. The piece of hardware can further be a single piece of hardware or multiple pieces of hardware working together.

The system 100 generates at least one command packet configured to instruct the piece of hardware to perform the desired action (1304). The command packet can be formed based on the CCSDS standard as described above and/or based on any other suitable standard. The system 100 generates at least one container packet for transmission to the remote spacecraft (1306). The container packet can be formed according to the SpaceWire standard as described above and/or any other suitable standard. The system 100 embeds the at least one command packet within the at least one container packet to yield at least one embedded packet such that the remote spacecraft decodes the at least one embedded packet and the at least one command packet to cause the piece of hardware to perform the desired action (1308). A SpaceWire bus driver can transmit the at least one container packet.

The system 100 transmits the at least one embedded packet to the remote spacecraft (1310) via a wired and/or wireless connection. As described in the tables above, the embedded packet can include a primary header, a secondary header, and command data. The command data can include a logical address of the piece of hardware, a protocol ID, and cargo data.

In one particular spacecraft configuration, a series of digital logic devices, or hardware, are connected together using the SpaceWire point-to-point network topology. Often, due to the highly parallel and lengthy development process of spacecraft, the hardware is not yet fully designed or specified when implementing control features in the hardware, such as enable/disable, set parameters, read out stored values. The approaches set forth herein provide a standardized and clearly defined bridge between the digital logic circuitry and the software to operate the hardware using SpaceWire or other links.

This approach embeds CCSDS packets within SpaceWire packets as that bridge. CCSDS packets provide a clearly defined ability for software to control specific hardware features to such as reading out values and controlling or writing other values. As one example, core flight executive (cFE) software can implement CCSDS packets as a messaging mechanism between the various software tasks or the software bus. By specifying how the hardware should behave when it receives CCSDS packets, developers and/or software can extend the CCSSDS packets to control the attached hardware.

The approaches disclosed herein can be applied in C&DH hardware and software that is relatively small size, light weight, and capable of performing several sophisticated space-based tasks. The C&DH system can utilize a versatile architecture and industry standards to provide high performance in a compact, reliable package. Due to its flexibility and modularity, any or all components of the C&DH system can be reused on other space missions with similar requirements and architecture.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied in various space-based projects or other projects in similar extreme conditions. The specific ranges, values, and examples provided herein are exemplary and should not be considered as limiting the claims. Those skilled in the art will readily recognize various modifications and changes that may be made to the principles described herein without following the example embodiments and applications illustrated and described herein, and without departing from the spirit and scope of the disclosure.

We claim:

1. A method of controlling hardware on a remote spacecraft, the method comprising:
identifying a piece of hardware on a remote spacecraft and a desired action for the piece of hardware;
generating at least one command packet configured to instruct the piece of hardware to perform the desired action;
generating at least one container packet for transmission to the remote spacecraft;
embedding the at least one command packet within the at least one container packet to yield at least one embedded packet such that the remote spacecraft decodes the at least one embedded packet and the at least one command packet to cause the piece of hardware to perform the desired action; and
transmitting the at least one embedded packet to the remote spacecraft.

2. The method of claim 1, wherein the at least one command packet is formed according to a Consultative Committee for Space Data Systems standard.

3. The method of claim 1, wherein the at least one container packet is formed according to a SpaceWire standard.

4. The method of claim 3, wherein a SpaceWire bus driver transmits the at least one container packet.

5. The method of claim 3, wherein the at least one embedded packet is transmitted wirelessly to the remote spacecraft.

6. The method of claim 1, wherein the desired action comprises at least one of reading data and writing data.

7. The method of claim 1, wherein the piece of hardware comprises a plurality of pieces of hardware.

8. The method of claim 1, wherein the at least one embedded packet comprises a primary header, a secondary header, and command data, and wherein the command data comprises a logical address of the piece of hardware, a protocol ID, and cargo data.

9. A non-transitory computer-readable storage medium storing instructions which, when executed by a computing device, cause the computing device to control hardware on a spacecraft, the instructions comprising:
receiving, at a spacecraft, a container packet embedded with a command packet;
extracting the command packet from the container packet;
decoding the command packet to identify a desired action and a piece of hardware; and
causing the piece of hardware to perform the desired action.

10. The non-transitory computer-readable storage medium of claim 9, wherein the at least one command packet is formed according to a Consultative Committee for Space Data Systems standard.

11. The non-transitory computer-readable storage medium of claim 9, wherein the at least one container packet is formed according to a SpaceWire standard.

12. The non-transitory computer-readable storage medium of claim 11, wherein a SpaceWire bus driver transmits the at least one container packet.

13. The non-transitory computer-readable storage medium of claim 11, wherein the at least one embedded packet is transmitted wirelessly to the remote spacecraft.

14. The non-transitory computer-readable storage medium of claim 9, wherein the desired action comprises at least one of reading data and writing data.

15. The non-transitory computer-readable storage medium of claim 9, wherein the piece of hardware comprises a plurality of pieces of hardware.

16. The non-transitory computer-readable storage medium of claim 9, wherein the at least one embedded packet comprises a primary header, a secondary header, and command data, and wherein the command data comprises a logical address of the piece of hardware, a protocol ID, and cargo data.

17. A robust fault-tolerant memory module comprising:
a plurality of strings of memory modules, wherein each string of memory modules comprises a plurality of connected memory dies, and wherein each connected memory die comprises a plurality of bits, wherein a first group of bits in each of the plurality of strings of memory modules is for storing user data and a second group of bits in each of the plurality of strings of memory modules is for storing check data associated with the user data; and
a correction module connected to each of the plurality of strings of memory modules, the correction module configured to detect and correct errors in the user data based on the check data and based on an error detection and correction algorithm.

18. The memory module of claim 17, wherein the correction module is further configured to detect errors periodically.

19. The memory module of claim 18, wherein the correction module is further configured to correct errors when a number of detected errors reaches an error threshold.

20. The memory module of claim 17, wherein bits of one memory word are distributed across multiple memory modules in the plurality of strings of memory modules.
